(19) United States
(12) Patent Application Publication
(10) Pub. No.: US 2017/0008245 A1
(43) Pub. Date: Jan. 12, 2017

(54) METHOD AND APPARATUS FOR CREATING HINGE/FOLDING POINTS IN LAMINATED PAPERBOARD

(71) Applicant: Kenneth K. Niemuth, Appleton, WI (US)

(72) Inventor: Kenneth K. Niemuth, Appleton, WI (US)

(73) Assignee: Dura-Fibre, LLC, Menasha, WI (US)

(21) Appl. No.: 15/202,798

(22) Filed: Jul. 6, 2016

Related U.S. Application Data
(60) Provisional application No. 62/190,612, filed on Jul. 9, 2015.

(51) Int. Cl. B31F 1/10; B31B 1/26; B31B 3/26; B31B 1/25

(52) U.S. Cl. CPC B31F 1/10; B31B 1/25; B31B 1/26; B31B 3/26; B31B 2201/257; B31B 2201/26; B31B 2203/066

(57) ABSTRACT

A method and apparatus for forming a fold line are provided. The apparatus is configured for applying an embossing blade assembly having at least one embossing blade against the paperboard, and linearly moving the embossing blade against the paperboard to form a plurality of parallel adjacent relief lines in the paperboard such that the plurality of parallel adjacent relief lines are immediately next to one another to form the fold line.

CROSS-REFERENCE TO RELATED PATENT APPLICATIONS

This patent application claims the benefit of U.S. Provisional Patent Application 62/190,612, filed Jul. 9, 2015, the entire teachings and disclosure of which are incorporated herein by reference thereto.

### FIELD OF THE INVENTION

This invention generally relates to packaging materials and equipment for forming the same, and more particularly to equipment for creating hinge/folding points in laminated paperboard.

### BACKGROUND OF THE INVENTION

As is known in the art, paperboard is utilized to create packaging such as foldable boxes or containers, as well as packaging support elements such as U-board or V-board support elements. Paperboard includes outer laminate sheets with a plurality of ply sheets interposed between the outer laminate sheets in a sandwich configuration.

In using such paperboard to form the above referenced packaging, it is necessary to fold the same into its desired configuration. In order to achieve such folds, the paperboard is typically scored along a hinge or fold line to allow for it to be readily folded into its desired configuration. This scoring is achieved by forming a shallow impression into the sheet, which helps fold the paperboard along this impression. To form such an impression, the paperboard is situated on a flat surface having a channel formed therein. The region of the paperboard which will receive the score is positioned over the channel, and a scoring device presses against the paperboard in this region. This pressing is done on the side of the paperboard opposite that side which faces the channel.

While the above method is satisfactory for relatively low thickness paperboard, as the thickness of the paperboard increases and/or the material strength of the particular type of paperboard increases, such a method is no longer satisfactory. Indeed, thicker paperboard typically has a sufficient “memory” such that the impression discussed above will not remain after being formed. As a result, a slit-score method must be employed, where the paperboard is die-cut into its thickness, and the paperboard is then folded away from such a cut. Such cutting unfortunately severely weakens the packaging along this cut line.

As another option, the paperboard is entirely severed through its thickness. A gap is then formed between the adjacent sections of cut paperboard. Additional laminate is applied on either side of the paperboard to cover the gap and allow for folding along the gap. This method also severely weakens the paperboard in this gap region. Further, this method requires the additional steps of applying additional laminates, which is more costly and time consuming.

As such, there is a need in the art for a method and apparatus which provides sufficiently strong hinge/fold lines in relatively thicker paperboard packaging.

The invention provides such a method and apparatus. These and other advantages of the invention, as well as additional inventive features, will be apparent from the description of the invention provided herein.

### BRIEF SUMMARY OF THE INVENTION

In one aspect, a method for forming a fold line in paperboard is provided. An embodiment of such a method includes applying an embossing blade assembly having at least one embossing blade against the paperboard. The method also includes one of linearly moving the embossing blade against the paperboard or linearly moving the paperboard against the embossing blade to form a plurality of parallel adjacent relief lines in the paperboard such that the plurality of parallel adjacent relief lines are immediately next to one another to form the fold line.

In certain embodiments, the step of forming the plurality of parallel adjacent relief lines includes compressing the paperboard such that no portion of the paperboard is severed in a region of the plurality of parallel adjacent relief lines. In certain embodiments, the step of forming the plurality of parallel adjacent relief lines includes compressing the paperboard such that a portion of the paperboard is severed in a region of the plurality of parallel adjacent relief lines. In such an embodiment, the portion of the paperboard that is severed is less than or equal 50% of an overall thickness of the paperboard.

In certain embodiments, the step of one of linearly moving the embossing blade against the paperboard or linearly moving the paperboard against the embossing blade includes utilizing an embossing blade assembly having a plurality of parallel adjacent embossing blades.

In certain embodiments, the step of one of linearly moving the embossing blade against the paperboard or linearly moving the paperboard against the embossing blade includes utilizing the embossing blade assembly having a plurality of parallel adjacent embossing blades with each embossing blade having identical tip geometry relative to one another. In certain other embodiments, the step of one of linearly moving the embossing blade against the paperboard or linearly moving the paperboard against the embossing blade includes utilizing the embossing blade assembly having a plurality of parallel adjacent embossing blades with each embossing blade having non-identical tip geometry relative to one another.

In certain embodiments, the method includes linearly moving the paperboard relative to the at least one embossing blade. In one embodiment, linearly moving the paperboard relative to the at least one embossing blade includes moving the paperboard along a supporting surface underneath the at least one embossing blade such that the paperboard is interposed between the at least one embossing blade and the supporting surface. In another embodiment, linearly moving the paperboard relative to the at least one embossing blade includes moving the paperboard through a pair of opposed rollers, wherein the at least one embossing blade is formed on one of said opposed rollers.

In another aspect, a method for forming paperboard packaging is provided. An embodiment of such a method includes applying an embossing blade assembly having at least one embossing blade against the paperboard. The method also includes one of linearly moving the embossing blade assembly against the paperboard or linearly moving the paperboard against the embossing blade to form at least one relief line therein. The method also includes folding the paperwork to form an interior enclosed space which is enclosed by the paperboard. In such a folded configuration, the relief line faces the interior enclosed space.

In certain embodiments, the step of forming the at least one relieve line includes compressing the paperboard such that no portion of the paperboard is severed in a region of the at least one relief line. In certain other embodiments, the step of forming the at least one relief line includes compressing the paperboard such that a portion of the paperboard is severed in a region of the at least one relief line. In such an embodiment, the portion of the paperboard that is severed is less than or equal 50% of an overall thickness of the paperboard.

In certain embodiments, the step of one of linearly moving the embossing blade assembly against the paperboard or linearly moving the paperboard against the embossing blade assembly includes utilizing an embossing blade assembly having a plurality of parallel adjacent embossing blades.

In certain embodiments, the step of one of linearly moving the embossing blade assembly against the paperboard or linearly moving the paperboard against the embossing blade assembly includes utilizing the embossing blade assembly having a plurality of parallel adjacent embossing blades with each embossing blades having identical tip geometry relative to one another. In certain other embodiments, the step of one of linearly moving the embossing blade assembly against the paperboard or linearly moving the paperboard against the embossing blade assembly includes utilizing the embossing blade assembly having a plurality of parallel adjacent embossing blades with each embossing blade having non-identical tip geometry relative to one another.

In yet another aspect, a method for forming a fold line in paperboard is provided. The paperboard includes first and second laminate sheets and a plurality of plied sheets situated between the first and second laminate sheets. Embodiment of such a method includes applying and embossing blade assembly having at least one embossing blade against the paperboard. The method also includes linearly moving the embossing blade assembly against the paperboard such that a relief line is formed, wherein at least some of the plurality of plies are severed and compressed in a region of the relief line.

In certain embodiments, the step of applying an embossing blade assembly includes applying an embossing blade assembly having a plurality of embossing blades arranged parallel to one another.

In certain embodiments, the step of applying the embossing blade assembly includes applying the embossing blade assembly having a plurality of embossing blades arranged parallel to one another, with each embossing blades having identical tip geometry relative to one another. In certain other embodiments, the step of applying the embossing blade assembly includes applying the embossing blade assembly having a plurality of embossing blades arranged parallel to one another, with each embossing blades having non-identical tip geometry relative to one another.

In certain embodiments, the step of linearly moving the embossing blade assembly against the paperboard or linearly moving the paperboard against the embossing blade assembly such that a relief line is formed wherein at least some of the plurality of plys are severed in a region of the relief line includes severing less than or equal to 50% of a thickness of the paperboard.

In certain embodiments, the step of linearly moving the embossing blade assembly against the paperboard or linearly moving the paperboard against the embossing blade assembly such that a relief line is formed includes forming a plurality of parallel adjacent relief lines simultaneously.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of an exemplary embodiment of an apparatus for creating hinge/fold points according to the instant invention;

FIG. 2 is a perspective view of the apparatus of FIG. 1, particularly an embossing blade thereof; emplacing a relief line into a paperboard substrate;

FIG. 3 is a perspective view of an embossing blade assembly simultaneously emplacing parallel relief lines into a paperboard substrate;

FIG. 4 is a front view of an embodiment of an embossing blade assembly of the invention;

FIG. 5 is a perspective view of a hinge/fold point formed into a paperboard substrate by a plurality of relief lines;

FIGS. 6 and 7 are exemplary embodiments of hinge/fold lines formed by the apparatus of FIG. 1;

FIGS. 8A and 8B are cross sectional views of paperboard substrates having relief lines formed by the method and apparatuses herein;

FIGS. 9 and 10 are partial perspective views of an alternative embodiment of an apparatus according to the teachings herein; and

FIG. 11 is a perspective view of another alternative embodiment of an apparatus according to the teachings herein.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Turning now to the drawings, an exemplary embodiment of an apparatus and its associated methods for forming hinge/fold lines (collectively referred to herein as fold lines) according to the teachings of the invention will be described. As will be understood from the following, the apparatus and its associated methods advantageously allow for the formation of fold lines in relatively thick paperboard without the need to sever significant portions or the entirety of paperboard. As a result, a relatively strong fold line is maintained.

The apparatus and methods achieve the foregoing result by utilizing an embossing blade assembly having at least one embossing blade which introduces one or more relief lines in the paperboard. Each relief line defines a region in which a significant compression of the paperboard has occurred so as to condition the paperboard to readily fold in this region. The Applicant has discovered that by introducing a plurality of adjacent parallel relief lines, paperboard of relatively large thickness can be readily folded using relatively small bending radii while forming bends having bend angles of greater than 180 degrees. Further, the Applicant has discovered that with the above configuration, a channel on the opposite side of the paperboard which receives the relief lines is no longer required. In other words, the paperboard may be situated against a channel-free flat surface on one side, and the relief lines placed on the other side.

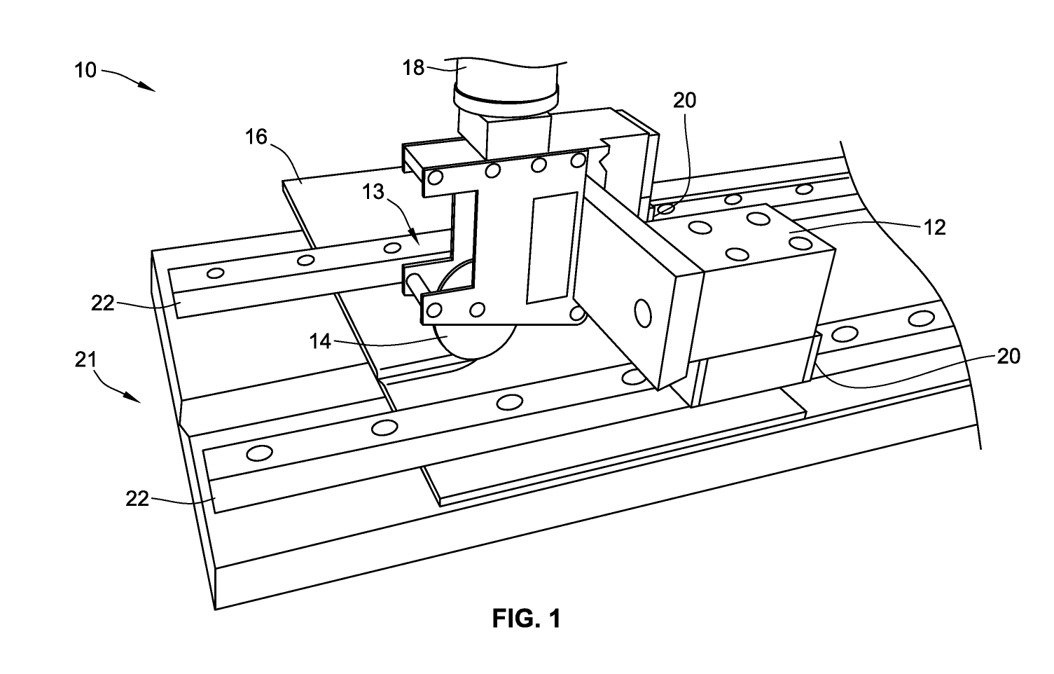

With particular reference now to FIG. 1, an embodiment of an apparatus 10 according to the teachings of the present invention is illustrated therein. Apparatus 10 includes a frame 12. An embossing blade assembly 13 is mounted to frame 12. Embossing blade assembly 13 includes one or more embossing blades 14 rotatably mounted to frame 12. This embossing blade 14 is biased into contact with a paperboard substrate 16 by way of an actuator 18 mounted to frame 12.

A pair of linear bearings 20 are also mounted to frame 12. A base 21 is positioned in proximity to frame 12. Base 21 includes a pair of opposed guide rails 22 as shown. Linear bearings 20 are slidably received on guide rails 22. As will be described in greater detail below, embossing blade 14 is slidably movable against substrate 16 to emplace one or more relief lines therein which will facilitate the formation of a fold line in the paperboard.

Although not shown in FIG. 1, a controller may also be provided to control the linear actuation force provided by actuator 18 to ensure that embossing blade 14 applies a sufficient compressive force within the region of the relief line. Also not shown in FIG. 1, an actuator for linearly moving frame 12 relative to base 21 may also be provided and be coupled to the aforementioned controller for adequate speed control during linear reciprocation of embossing blade 14 against substrate 16.

Also not shown in FIG. 1, in an alternative arrangement, paperboard 16 may be moved relative to embossing blade assembly 13 to achieve the relief lines discussed herein. For example, the embossing blade assembly 13 may be situated in-line with a laminator or other device used for forming/modifying the paperboard. In such a configuration, paperboard substrate 16 is fed through the device, e.g. laminator, and then continues being fed linearly such that it moves against and relative to embossing blade assembly 13. As such, the embodiments described herein contemplate arrangements where embodiments where embossing blade assembly 13 moves relative to paperboard substrate 16, and where paperboard substrate 16 moves relative to embossing blade assembly 13.

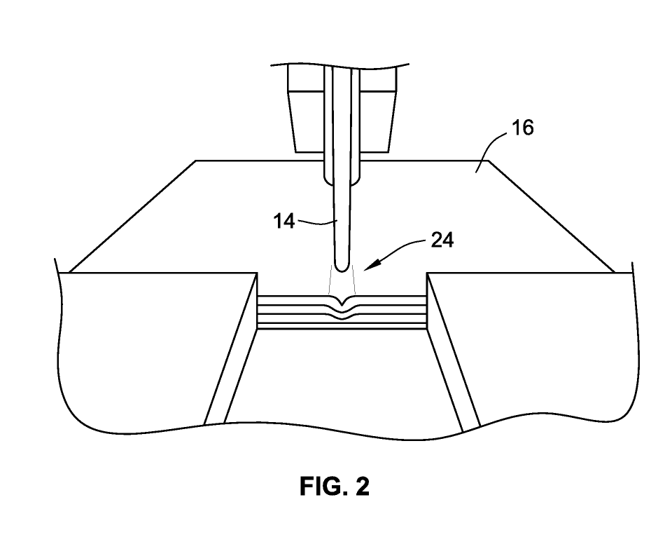

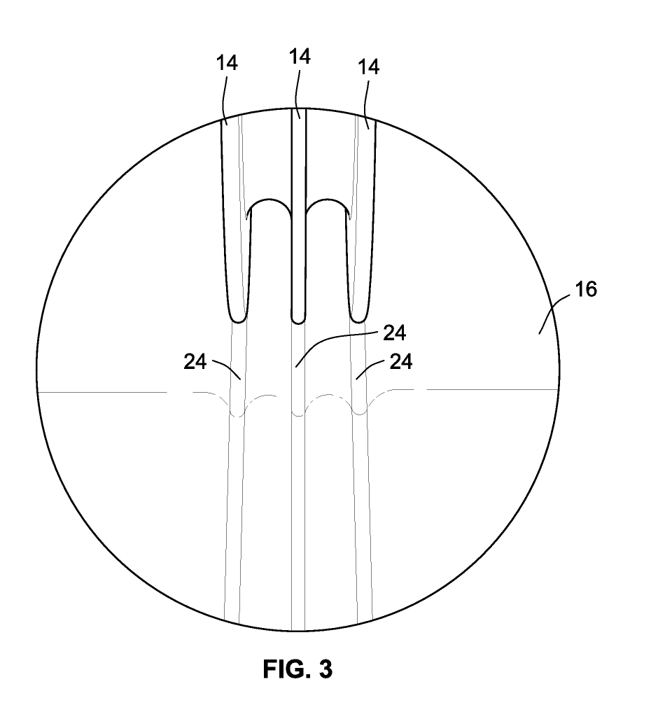

Turning now to FIG. 2, the aforementioned relief line 24 is shown as it is formed by embossing blade 14 in substrate 16. As can be seen therein, embossing blade 14 conditions paperboard 16 in the area of relief line 24 so as to impart a compressive stress therein. It is this compressive stress that conditions paperboard 16 so that it may be readily folded. It will be noted that in FIG. 2 a single relief line 24 is shown. At relatively small substrate thicknesses and/or relatively large bend angles in the substrate, a single relief line may be all that is necessary to emplace an adequate fold line for folding the paperboard. However, and with reference now to FIG. 3, thicker paperboard and/or greater bend angles may be achieved by emplacing a plurality of adjacent parallel relief lines 24 as shown. As can be seen in FIG. 3, these relief lines are immediately adjacent one another to define a fold line. As can also be seen in FIG. 3, an embossing blade assembly defined by a number of embossing blades is utilized to simultaneously emplace the plurality of relief lines. However, it is also contemplated by the invention herein that a single embossing blade 14 may be utilized to sequentially place each parallel adjacent relief line 24 as illustrated.

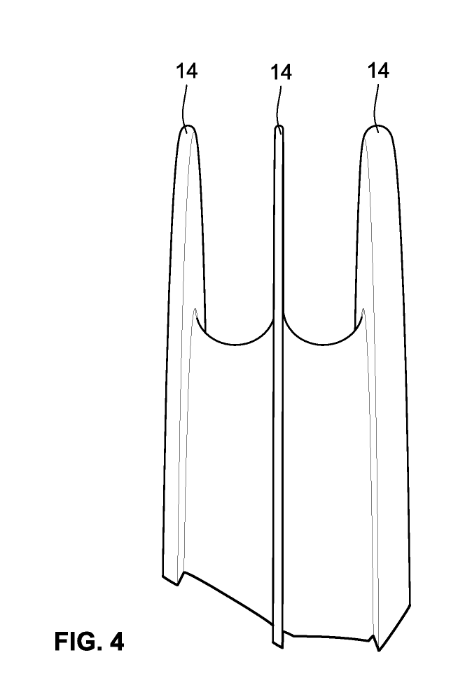

With reference now to FIG. 4, the embossing blade assembly may utilize embossing blades 14 having identical tip geometry, or alternatively, having differing tip geometry depending upon the particular fold line desired. For example, it may be desirable to have duller embossing blade at the extremities of the embossing blade assembly, while having sharper embossing blades 14 interposed between these duller embossing blades 14. As an example, a blade with tip radius of between about 0.001 inches and about 0.125 inches may be utilized. However, those skilled in the art will readily recognize that various tip radii may be employed depending upon the desired characteristics of the relief line.

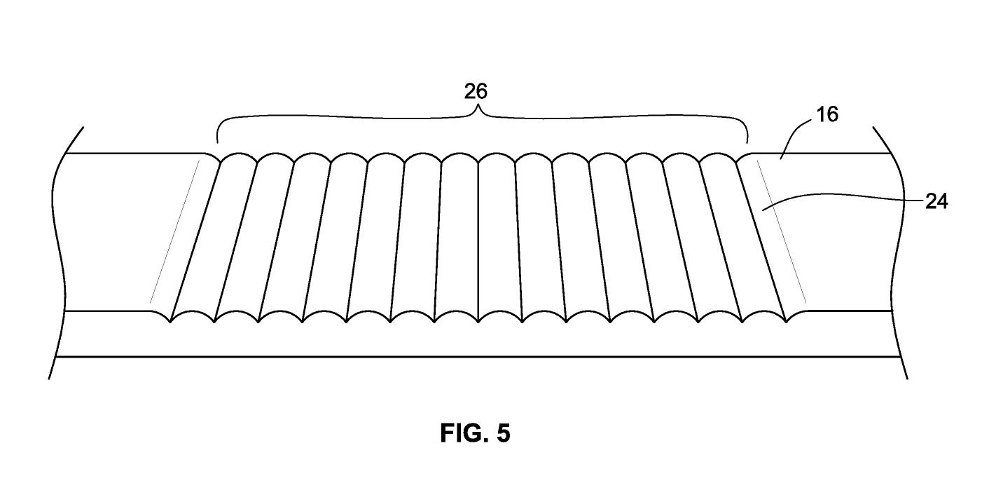

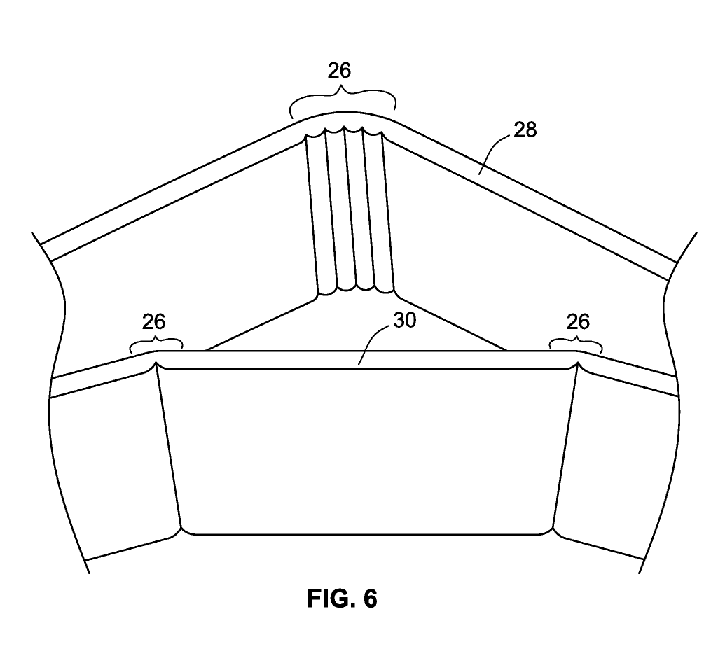

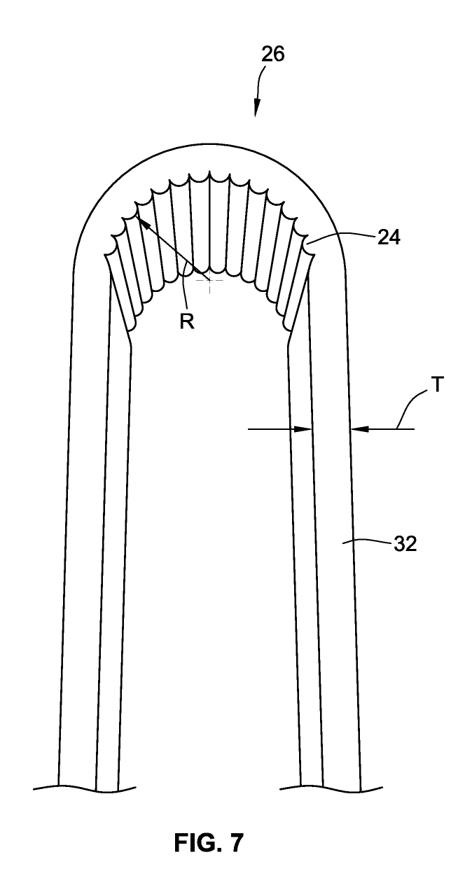

Turning now to FIG. 5, an exemplary embodiment of a fold line 26 formed by a plurality of adjacent parallel relief lines 24 is illustrated. As can be seen in this view, the paperboard substrate 16 is relatively thick however, by way of the use of multiple relief lines 24, the paperboard in the region of the fold line 26 is sufficiently conditioned by way of compressive stress to allow folding thereof into bend angle of 90° such as that shown in the exemplary component 28 of FIG. 6, as well as 180° as shown in the exemplary component 32 of FIG. 7.

With continued reference to FIG. 7, a substrate of relatively high thickness T is illustrated. Despite this high thickness, the use of multiple relief lines 24 allows for a bend radius of approximately 0.5 inch and a bend angle of 180°. Such dimensions were heretofore not possible using paperboard having substrate thickness T. Instead, the prior methodologies of severing a significant portion of the paperboard or the entirety of the paperboard would be necessary.

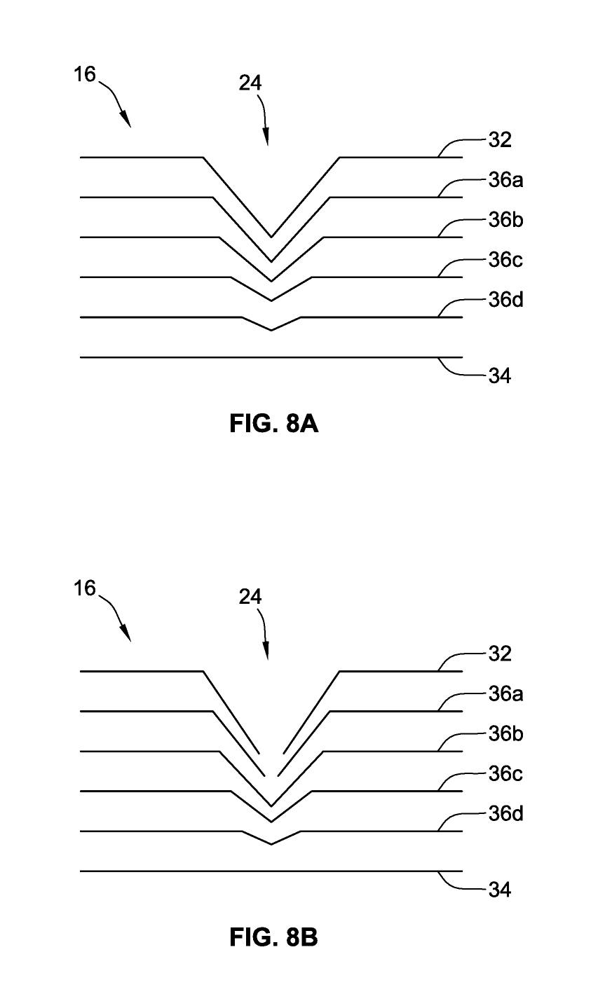

Turning now to FIGS. 8A and 8B, cross-sectional examples of the above-described relief line 24 are illustrated. With particular reference to FIG. 8A, paperboard substrate 16 includes first and second outer laminates 32, 34. A plurality of plies 36A-36D are positioned between first and second laminates 32, 34. Relief line 24 has been emplaced in substrate 16 such that first laminate 32 and plies 36A-36D are compressively deformed without severing any of the same. In the alternative embodiment illustrated in FIG. 8B, the first outer laminate 32 as well as ply 36A have been entirely severed while ply 36B, ply 36C, ply 36D and second outer laminate 34 remain intact. Unlike prior designs and methods which typically require severing more than 50% of the total number of plies positioned between the laminates of the paperboard, it is possible with the instant apparatus and methods to sever less than about 30% of the plies to achieve a desired relief line. It will be recognized, however, that the total number of plies severed will ultimately be dictated by substrate thickness, and material properties.

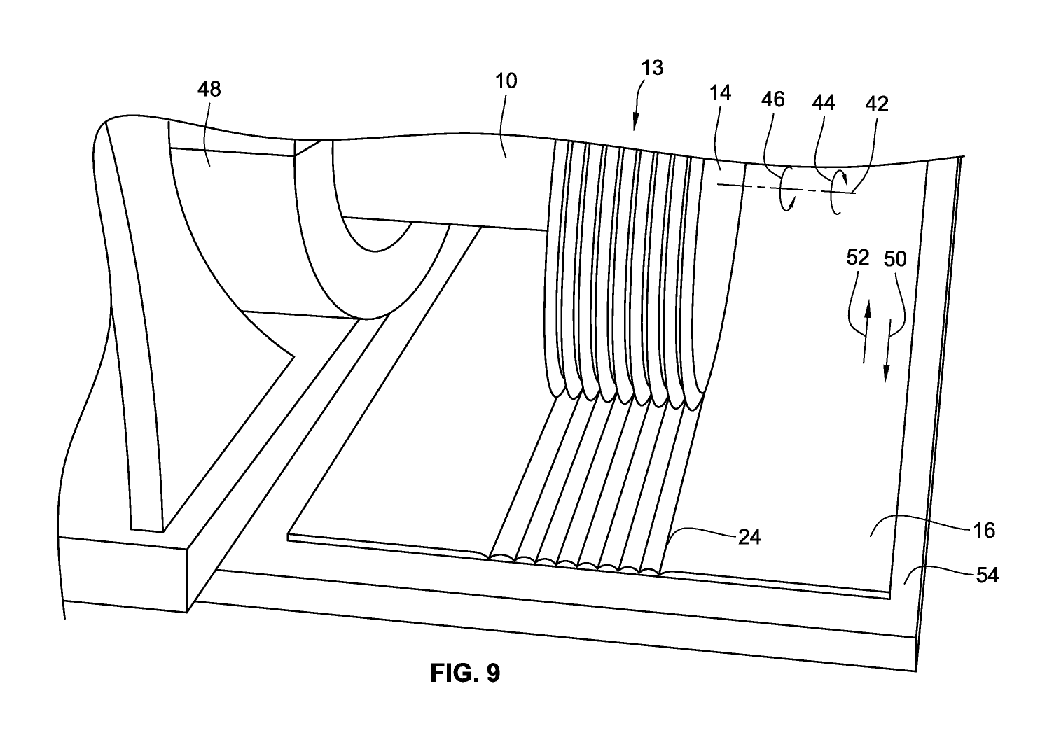

Turning now to FIG. 9, an alternative embodiment of an apparatus according to the teachings herein. As introduced above, in this alternative configuration, paperboard 16 is moved relative to an embossing blade assembly 13 comprising a plurality of embossing blades. Embossing blade assembly is mounted to a shaft 40 which defines an axis 42. Each embossing blade 14 is rotatable in either of rotatable directions 44, 46 about axis 42 as shown. Shaft 40 is mounted to a frame 48 associated with a work table 54. Paperboard 16 is movable along work table 54 in linear directions 50, 52 as shown. Such movement may be achieved by rollers or other means situated upstream or downstream from embossing blade assembly 13.

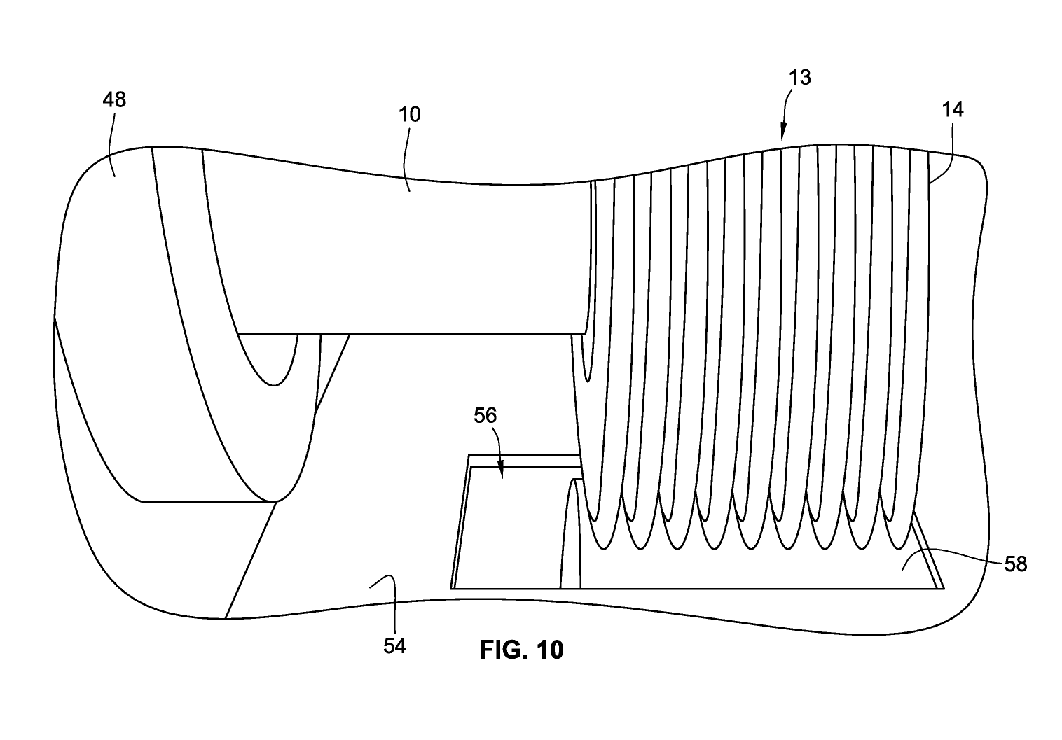

With reference now to FIG. 10, work table 54 may include an aperture 56 formed therein in the region immediately adjacent embossing blade assembly 13 as shown. A roller 58 may be situated beneath embossing blade assembly. This aperture 56 permits the working outer peripheral edge of each embossing blade to extend below the top of work table 54 to allow for sufficient compression of paperboard 16. Roller 56 advantageously provides a support surface in this region as well as a means for smoothly feeding paperboard 16 relative to work table 54. The relative distance between the outer peripheral edges of embossing blade assembly 13 may be adjusted relative to work table 54 to accommodate paperboard 16 of differing thicknesses.

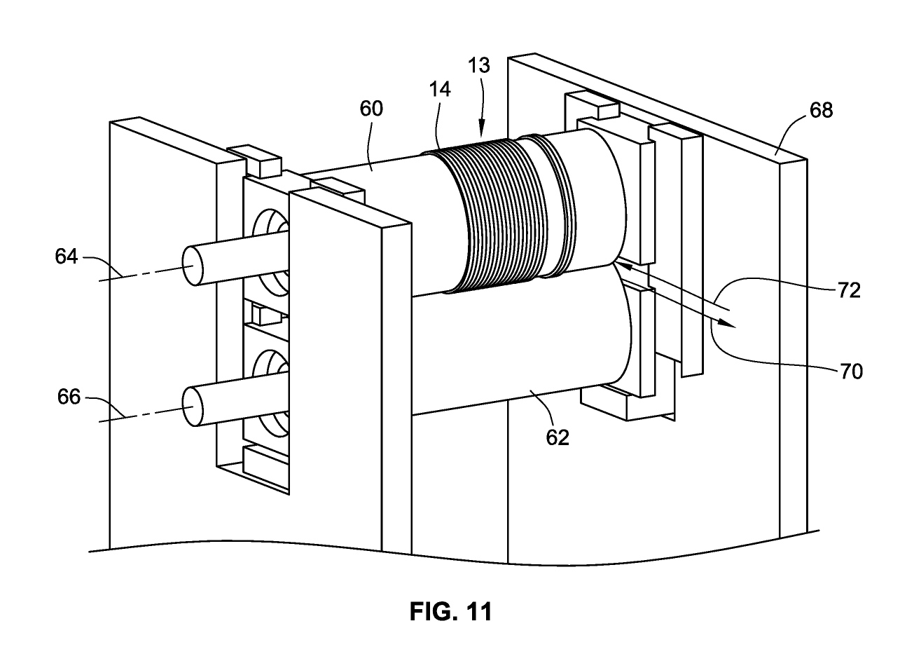

Turning now to FIG. 11, another alternative embodiment of an apparatus according to the teachings herein is illustrated. As was the case with the embodiment shown in FIGS. 9 and 10, this embodiment is configured such that paperboard 16 moves relative to an embossing blade assembly 13. In this implementation, embossing blade assembly 13 is formed on an upper roller 60. A lower roller 62 is also provided such that paperboard 16 may be fed through rollers 60, 62 in linear directions 70, 72. Each roller 60, 62 is rotatably mounted on a respective shaft 64, 66, which in turn are mounted to a frame 68. Although not illustrated, conveyor belts or the like may be positioned on either side of rollers 60, 62 to support and convey paperboard 16 as it is fed through rollers 60, 62. The relative distance between rollers 60, 62 may be adjusted to accommodate paperboard 16 of differing thicknesses.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for forming a fold line in paperboard, the method comprising:
applying an embossing blade assembly having at least one embossing blade against the paperboard;
one of linearly moving the embossing blade against the paperboard or linearly moving the paperboard against the embossing blade to form a plurality of parallel adjacent relief lines in the paperboard such that the plurality of parallel adjacent relief lines are immediately next to one another to form the fold line.

2. The method of claim 1, wherein the step of forming the plurality of parallel adjacent relief lines includes compressing the paperboard such that no portion of the paperboard is severed in a region of the plurality of parallel adjacent relief lines.

3. The method of claim 1, wherein the step of forming the plurality of parallel adjacent relief lines includes compressing the paperboard such that a portion of the paperboard is severed in a region of the plurality of parallel adjacent relief lines.

4. The method of claim 3, wherein the portion of the paperboard that is severed is less than or equal 50% of an overall thickness of the paperboard.

5. The method of claim 1, wherein the step of one of linearly moving the embossing blade against the paperboard or linearly moving the paperboard against the embossing blade includes utilizing an embossing blade assembly having a plurality of parallel adjacent embossing blades.

6. The method of claim 5, wherein the step of one of linearly moving the embossing blade against the paperboard or linearly moving the paperboard against the embossing blade includes utilizing the embossing blade assembly having a plurality of parallel adjacent embossing blades with each embossing blade having identical tip geometry relative to one another.

7. The method of claim 5, wherein the step of one of linearly moving the embossing blade against the paperboard or linearly moving the paperboard against the embossing blade includes utilizing the embossing blade assembly having a plurality of parallel adjacent embossing blades with each embossing blade having non-identical tip geometry relative to one another.

8. The method of claim 1, wherein the method includes linearly moving the paperboard relative to the at least one embossing blade.

9. The method of claim 8, wherein linearly moving the paperboard relative to the at least one embossing blade includes moving the paperboard along a supporting surface underneath the at least one embossing blade such that the paperboard is interposed between the at least one embossing blade and the supporting surface.

10. The method of claim 8, wherein linearly moving the paperboard relative to the at least one embossing blade includes moving the paperboard through a pair of opposed rollers, wherein the at least one embossing blade is formed on one of said opposed rollers.

11. A method for forming paperboard packaging, the method comprising;
applying an embossing blade assembly having at least one embossing blade against the paperboard;
one of linearly moving the embossing blade assembly against the paperboard or linearly moving the paperboard against the embossing blade assembly to form at least one relief line therein;
folding the paperboard to form an interior enclosed space which is enclosed by the paperboard, wherein the relief line faces the interior enclosed space.

12. The method of claim 11, wherein the step of forming the at least one relieve line includes compressing the paperboard such that no portion of the paperboard is severed in a region of the at least one relief line.

13. The method of claim 11, wherein the step of forming the at least one relief line includes compressing the paperboard such that a portion of the paperboard is severed in a region of the at least one relief line.

14. The method of claim 13, wherein the portion of the paperboard that is severed is less than or equal 50% of an overall thickness of the paperboard.

15. The method of claim 11, wherein the step of one of linearly moving the embossing blade assembly against the paperboard or linearly moving the paperboard against the embossing blade assembly includes utilizing an embossing blade assembly having a plurality of parallel adjacent embossing blades.

16. The method of claim 15, wherein the step of one of linearly moving the embossing blade assembly against the paperboard or linearly moving the paperboard against the embossing blade assembly includes utilizing the embossing blade assembly having a plurality of parallel adjacent embossing blades with each embossing blades having identical tip geometry relative to one another.

17. The method of claim 15, wherein the step of one of linearly moving the embossing blade assembly against the paperboard or linearly moving the paperboard against the embossing blade assembly includes utilizing the embossing blade assembly having a plurality of parallel adjacent embossing blades with each embossing blade having non-identical tip geometry relative to one another.

18. A method for forming a fold line in paperboard, the paperboard having first and second laminate sheets and a plurality of ply sheets situated between the first and second laminate sheets, the method comprising:
applying an embossing blade assembly having at least one embossing blade against the paperboard;
one of linearly moving the embossing blade assembly against the paperboard or linearly moving the paperboard against the embossing blade assembly such that a relief line is formed wherein at least some of the plurality of plys are severed in a region of the relief line.

19. The method of claim 18, wherein the step of applying an embossing blade assembly includes applying an embossing blade assembly having a plurality of embossing blades arranged parallel to one another.

20. The method of claim 19, wherein the step of applying the embossing blade assembly includes applying the embossing blade assembly having a plurality of embossing blades arranged parallel to one another, with each embossing blades having identical tip geometry relative to one another.

21. The method of claim 19, wherein the step of applying the embossing blade assembly includes applying the embossing blade assembly having a plurality of embossing blades arranged parallel to one another, with each embossing blades having non-identical tip geometry relative to one another.

22. The method of claim 18 wherein the step of linearly moving the embossing blade assembly against the paperboard or linearly moving the paperboard against the embossing blade assembly such that a relief line is formed wherein at least some of the plurality of plys are severed in a region of the relief line includes severing less than or equal to 50% of a thickness of the paperboard.

23. The method of claim 18, wherein the step of linearly moving the embossing blade assembly against the paperboard or linearly moving the paperboard against the embossing blade assembly such that a relief line is formed includes forming a plurality of parallel adjacent relief lines simultaneously.
